(19) United States
(12) Patent Application Publication
(10) Pub. No.: US 2008/0072131 A1
(43) Pub. Date: Mar. 20, 2008

(54) Methods, Systems, and Devices for Creating, Storing, Transferring and Manipulating Electronic Data Layers

(76) Inventors: Frederick A. Reddel V, Greensboro, NC (US); W. Douglas Young, Summerfield, NC (US); Aaron K. Pickrell, Greenboro, NC (US)

Correspondence Address: KILPATRICK STOCKTON LLP, 1001 WEST FOURTH STREET, WINSTON-SALEM, NC, 27101, US

(21) Appl. No.: 11/853,492

(22) Filed: Sep. 11, 2007

Related U.S. Application Data
(60) Provisional application No. 60/843,664, filed on Sep. 11, 2006.
(60) Provisional application No. 60/843,889, filed on Sep. 12, 2006.

(51) Int. Cl. G06F 17/30

(52) U.S. Cl. 715/202; 715/200

(57) ABSTRACT

Methods and systems for creating, storing, transferring and manipulating electronic data layers employ computer hardware and software including instructions embodied in program code encoded on machine readable medium to provide, for example, one or more first layers of electronic data and one or more second layers of electronic data associated with a predetermined portion of the first layer of electronic data. The first and second layers of electronic data are stored independently of one another on the same or different databases, and the first layer of electronic data can be accessed and presented by a viewer application on a client device together with the second layer of electronic data in association with the predetermined portion of the first layer of electronic data.

### PRIORITY APPLICATION

This application claims priority to co-pending U.S. Provisional Application No. 60/843,664 filed Sep. 11, 2006, entitled “DATA LAYERS” and co-pending U.S. Provisional Application No. 60/843,889 filed Sep. 12, 2006, entitled “DATA LAYERS”, each of which is incorporated herein by this reference.

### FIELD OF THE INVENTION

The present invention relates to data layers and to layering. Embodiments of the present invention provide data layers, files comprising data layers, systems and method for creating data layers, systems and methods for collecting, transmitting and collating data layers; systems and methods for using data layers; and computer readable media comprising data layers and the foregoing systems and methods. The layers may be collated through a layering process.

### BACKGROUND OF THE INVENTION

Electronic data has generally been stored and collated in files. For example, a word processing file (e.g. a Microsoft® Word file) may comprise electronic data relating to the substance and layout of a document. In a traditional file structure, when a file (e.g. a document file) is modified, the modified data becomes part of the underlying file data such that the file comprises the original electronic data and the modified electronic data. As a result the file grows in size.

The growth and popularity of multimedia data, including audio, video, picture and/or graphic has also led to file growth as these file types, and others, may comprise a large amount of electronic data. The inclusion of multimedia data within another file, e.g. a word processing file, may greatly increase the file size of the original formatted text file.

Although computer processing speeds have increased, and the bandwidth available electronic data transmission has also increased, large files may still be disadvantageous for transmission, storage and/or use. For example, large files may be difficult to transfer over data communication networks to mobile communication devices such as cell phones. In addition, large files may be hard to use on certain communication devices.

In addition to the issues noted above with respect to file size and the need for a solution, it would be advantageous to have a new paradigm for data storage, transfer and manipulation for other reasons. For example, it would be advantageous to have a new paradigm that facilitates collaboration, file pushing and pulling, and/or review of files and is platform agnostic such that it may be utilized by mainframe, mini, and personal computers, personal digital assistants, cell phones, mobile communication devices, electronic tablets and the like.

### SUMMARY OF THE INVENTION

The present invention provides a new paradigm for the management of electronic data that overcomes the disadvantages, and achieves the advantages set forth above, as well as other advantages. The conceptual shift provided by the present invention relates to the use of layers or layering. A layer comprises data. Multiple layers may be superimposed to align data provided on an upper layer with data provided on one or more lower layers.

The conceptual underpinnings of embodiments of the present invention may be understood with reference to physical layers. For example, a bottom data layer may comprise a document, e.g a word processing or Acrobat® document, that may be conceptualized as words on a sheet of paper. A second layer, on top of the bottom layer, may comprise data in the form of text that is associated with a particular piece of text in the bottom layer. This second layer may be visualized as a transparent sheet, or pane of glass, with the text in a particular section of the sheet such that when the bottom layer and second layer are aligned, the text on the second layer is positioned proximate to a particular piece of text in the bottom layer. The virtual endpoint coordinates of the second layer, however, need not be the same as the bottom layer (i.e. the layers need not be the same size), rather the second layer could have smaller virtual endpoints. In this embodiment, the second layer may be conceptualized as a PostIt® Note placed proximate to text n the bottom layer. The second layer may comprise a graphic, such as an electronic representation of pen strokes of a user.

Although a conceptual representation of the present invention has been described with text files, the layers may comprise any type of file. For example, a layer may comprise a text file, a document file, a picture file, a graphic file, a video file, an HTML file, an audio file and so on.

For example, in an embodiment of the present invention a second layer may comprise an audio file. The audio file may comprise information relating to a file in the bottom layer, e.g. text in the bottom layer and may be positioned, or may be linked to a marker positioned, to a particular location in the bottom layer (for example particular text in the bottom layer).

In a similar fashion, third, fourth, fifth etc. may be layered over the bottom and second layers. The additional layers may comprise files positioned proximate to the same position as the file in the second layer, or positioned proximate to other positions in any other layer.

Layering as envisioned by the present invention, has many advantages over traditional file storage. Layering allows for collaboration among persons reviewing a particular file. For example, a bottom layer may comprise a PowerPoint presentation file, and a second layer may comprise an audio file comment on a bullet point on the third slide.

Layering has advantages for file storage and transmission. The individual layers may be stored separately and then collated. The number of bytes (size) of any individual layer may be smaller than the collated whole, and the layers may be more easily transmitted electronically and locally processed, particularly to mobile communication devices (cell phones, personal digital assistants etc.) where bandwidth and processor speeds are potential issues.

To achieve the stated and other features, advantages and objects, embodiments of the present invention employ computer hardware and software, including, without limitation, instructions embodied in program code encoded on machine readable medium, to propose methods and systems for creating, storing, transferring and manipulating electronic data layers that involve, for example, providing one or more first layers of electronic data, providing one or more second layers of electronic data associated with a predetermined portion of the first layer of electronic data, storing the first and second layers of electronic data independently of one another, and presenting the first layer of electronic data together with the second layer of electronic data in association with the predetermined portion of the first layer of electronic data.

In embodiments of the invention, the first layer of electronic data comprises a word processing electronic data file consisting at least in part of electronic data relating to a substance and layout of a document. In other embodiments, the first layer of electronic data comprises multimedia electronic data consisting of one or more of audio, video, picture, and graphic electronic data. In further embodiments of the invention, the first layer of electronic data comprises multimedia electronic data within an original formatted text file. In still further embodiments, the first layer of electronic data comprises electronic data representing any form of presenting data to a user including, for example, any of a text file, a document file, a picture file, a graphic file, a video file, an HTML file, and/or an audio file.

According to embodiments of the invention, the first and second layers of electronic data comprise electronic data files of different sizes. According to further embodiments, the second layer of electronic data comprises electronic data representing an audio file with a recorded message replayable for a user while viewing a word processing file represented by the first layer of electronic data. In other embodiments, the second layer of electronic data comprises electronic data representing text that is associated with text represented by the predetermined portion of the first layer of electronic data. In additional embodiments of the invention, the second layer of electronic data comprises electronic data representing any of a text file, a document file, a picture file, a graphic file, a video file, an HTML file, and/or an audio file.

In embodiments of the invention, the second layer of electronic data comprises electronic data representing an audio file having information relating to a predetermined portion of text represented by the first layer of electronic data, and in further embodiments, the audio file comprises electronic data representing comments on the predetermined portion of text represented by the first layer of electronic data. Other embodiments of the invention involve providing, for example, a number of additional layers of electronic data associated with at least one predetermined portion of the first layer of electronic data, and in additional embodiments, the additional layers of electronic data comprise electronic data representing files relating to a plurality of different predetermined portions of the first layer of electronic data.

Other embodiments of the invention propose, for example, providing a viewer having coordinate generating code that identifies a position of the predetermined portion of the first layer of electronic data with which to associate the second layer of electronic data. In additional embodiments, the first and second layers of electronic data are collated after being stored, and in further embodiments, the first and second layers of electronic data are stored as separate electronic data files. Further embodiments involve, for example, providing a data table that references a storage location for each of the layers. In still further embodiments, the first layer of electronic data is presented together with the second layer of electronic data in association with the predetermined portion of the first layer of electronic data on a communication device, such as a wireless communication device, via a communications network

In further embodiments of the invention, the first layer of electronic data is presented together with the second layer of electronic data in association with the predetermined portion of the first layer of electronic data on a plurality of a different communication devices independently of one another. In still further embodiments, the first layer of electronic data is presented together with the second layer of electronic data in association with the predetermined portion of the first layer of electronic data simultaneously on a plurality of a different communication devices independently of one another

Another aspect of embodiments of the invention proposes machine-readable media embodying a file structure for creating, storing, transferring and manipulating electronic data layers including, for example, a first layer of electronic data stored on a data storage device, at least a second layer of electronic data associated with a predetermined portion of the first layer of electronic data and stored on a data storage device independently of the first layer of electronic data, and a viewer coupled to the data storage device via a network presenting the first layer of electronic data together with the second layer of electronic data in association with the predetermined portion of the first layer of electronic data.

An additional aspect of embodiments of the invention proposes machine-readable medium on which is encoded program code for creating, storing, transferring and manipulating electronic data layers, the program code comprising instructions, for example, for providing at least a first layer of electronic data, providing at least a second layer of electronic data associated with a predetermined portion of the first layer of electronic data, storing the first and second layers of electronic data independently of one another, and presenting the first layer of electronic data together with the second layer of electronic data in association with the predetermined portion of the first layer of electronic data.

A further aspect of embodiments of the invention proposes a computer system for creating, storing, transferring and manipulating electronic data layers including, for example, a database storing at least a first layer of electronic data, either the same database or a second database storing at least a second layer of electronic data associated with a predetermined portion of the first layer of electronic data, and a viewer coupled to the database or databases storing the first layer and second layers of electronic data via a network presenting the first layer of electronic data together with the second layer of electronic data in association with the predetermined portion of the first layer of electronic data.

Additional objects, advantages and novel features of the invention will be set forth in part in the description which follows, and in part will become more apparent to those skilled in the art upon examination of the following, or may be learned from practice of the invention.

### BRIEF DESCRIPTION OF THE DRAWINGS

FIG. 1 is a schematic diagram that illustrates an overview example of key components and the flow of information between key components for the methods and systems for creating, storing, transferring and manipulating electronic data layers of embodiments of the invention;

FIG. 2 is a flow chart that illustrates an overview example of the process of creating, storing, transferring and manipulating electronic data layers for the methods and systems of embodiments of the invention; and

FIG. 3 is a flow chart that illustrates an example of the process of creating, storing, transferring and manipulating electronic data layers in the form of electronic data files for the methods and systems of embodiments of the invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used on another embodiment to yield a still further embodiment. Thus, it is intended that the present invention cover such modifications and variations that come within the scope of the invention.

As set forth above, the present invention provides a conceptual shift in the management of data associated with files. In an embodiment, the present invention provides a data layer. The data layer may comprise electronic data. The electronic data may represent text, audio, visual, audio/visual, HTML content, and/or other forms of presenting data to a user.

An embodiment of the present invention comprises a plurality of data layers. A first data layer may comprise and/or be associated with a particular file type, such as a word processing file, presentation file, movie file, audio file, spreadsheet file and/or combinations thereof. An additional data layer may comprise and/or be associated with the same file type or a different file type. Similarly, further additional layers may comprise and/or be associated with similar file types.

In an embodiment of the present invention, the data layers are associated with each other such that the plurality of data layers may be viewed as a whole. For example, a first data layer comprising a word processing file may be associated with an additional data layer comprising an audio file such that a user may listen to the audio file while viewing the word processing file. As described above, the additional data layer, or a portion thereof, may be positioned proximate to a particular location on the first data layer, such that, in this example, the audio file comprises comments on a particular piece of text in the first data layer. Such an embodiment of the present invention may be advantageous for collaboration among users, for example, in reviewing the first data layer comprising the word processing file.

An embodiment of the present invention comprises a viewer, implementable in platform agnostic computer code, that enables viewing of a layer or layers of the present invention. The viewer may allow layers of the present invention to be viewed on computer monitors, personal digital assistants, mobile communications devices, cell phones and the like.

The viewer may comprise coordinate generating code. The coordinate generating code may be used to determine the position of particular data on a first layer such that data on an additional layer may be associated with the data on the first layer and if desired, located proximate to the first layer. For example, a viewer may comprise a tool bar that includes an location icon, e.g. a representation of a thumb tack. A click on the thumbtack would change the cursor into a thumbtack, and then the thumbtack may be positioned next to an item to be annotated in the first layer. A mouse click would “fix” the thumbtack. The coordinates, in two, three or more dimensions depending on the file type of the first layer, would be captured when the thumbtack is fixed.

In one embodiment, two dimensional coordinates of a thumbtack are combined with a page number, and stored as a coordinate triplet, X, Y, and N, on a database. When the viewer displays one or more layers, the display could be at some given scale, S. The viewer would divide the scale S to obtain a working scalar, M, for the triplet coordinates. When the viewer accesses the document layer, the viewer can obtain all existing thumbtack coordinate triplets from the database. Then, the viewer would overlay the coordinate triplets on the document layer, multiplying the X and Y coordinates by the M scalar, to obtain the corresponding position of the coordinates of the thumbtack on the data layer shown.

The mouse click may also provide, for example, a pop-up window, for the entry of data on an additional layer. If the additional layer comprises text data, that information could be typed into the window, or if the additional layer comprises audio data, the audio file could be generated through capturing the annotator's voice. Once the annotation is complete, the window could be closed, and the information saved as an additional layer.

An advantage of the layers of the present invention is that in an embodiment of the present invention the layers may be associated with each other, but handled and stored as separate electronic data files. In the example embodiment described in the preceding paragraphs, the first layer may comprise a relatively large word processing, powerpoint or spreadsheet file, comprising multiple kilobytes of electronic data. As such, the first layer may require longer transmission, download or processing times. The additional layer, by contrast, may be smaller, particularly if a simple text file. The additional layer may therefore be more easily stored, and/or more quickly transmitted/processed than the first layer. As a result, the additional layer will be advantageous for use on mobile communication devices, personal digital assistants, cell phones and similar devices where processing and communication speeds tend to limit usability.

In an embodiment of the present invention, regardless of the size of various layers, each layer file may be stored, transmitted and processed independently from each other layer, or in combination with other layers. One method of storing, transmitting and processing layers according to an embodiment of the present invention is set forth in the following paragraphs.

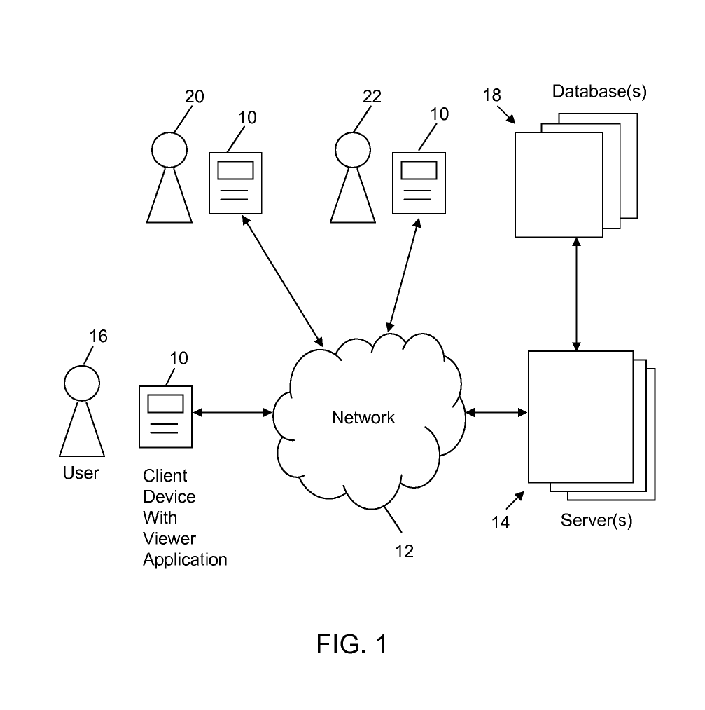

FIG. 1 is a schematic diagram that illustrates an overview example of key components and the flow of information between key components for embodiments of the invention.

Referring to FIG. 1, the viewer comprises an application that sits on a client device 10, such as a computer, a mobile communication device, a cell phone, a personal digital assistant, or the like. Part of the application may comprise an API. The API may be plugged into a number of different types of applications. For example, an API may comprise an Microsoft Outlook® Plug-in. In an embodiment, the present invention comprises an Instant Messaging Plug-In. The API may run on the client device 10 and communicate via a network 12, such as a telecommunications network, the internet, or other means to one or more servers 14.

Information relating to the layers is communicated to the server 14. For example, as soon as a user 16 clicks on a position in a file in the preceding example, the software takes the X, Y coordinates and does a calculation to figure out exactly where the clicked position is in the document. Then, the comment typed, or recorded, is communicated to the server 14. This additional layer includes electronic data associating it with the first layer.

The server(s) 14 comprise(s) one or more databases 18 that store the layers. The layers may be stored in the same or different locations. In an embodiment, depending on the type of layer, whether it's text, it's just a field in the database 18, if it is a voice, it would be a reference to a voice file somewhere else, and that could be stored anywhere. For example, voice files may be stored on a media server. The server 14 may also comprise a data table that references the storage location for each layer.

In an embodiment the data table may comprise a user table. The table may comprise a User ID column, a filename, file ID. The file ID may be used to associate layers connected with the file.

As will be appreciated from the description contained herein, the layers of the present invention may be advantageously utilized in a number of ways.

For example, embodiments of the present invention may be utilized with picture or video files. In an example of this type of embodiment, the user may wish to take a picture or video of his/her child. The picture may form a first layer. The child may then annotate the picture with a voice recording that forms an additional layer. The user, or other children, may also annotate the picture with additional voice recordings forming further additional layers. The picture with the additional layers may be transmitted to a relative, e.g. grandparent, who will be able to view the picture and hear the voices.

Another potential advantageous use for embodiments of the present invention is advertising. An advertising layer may be inserted over a document layer, or other content layer, being viewed on a cell phone. The advertising layer will use less bandwidth and take less space than traditional html pop-up windows.

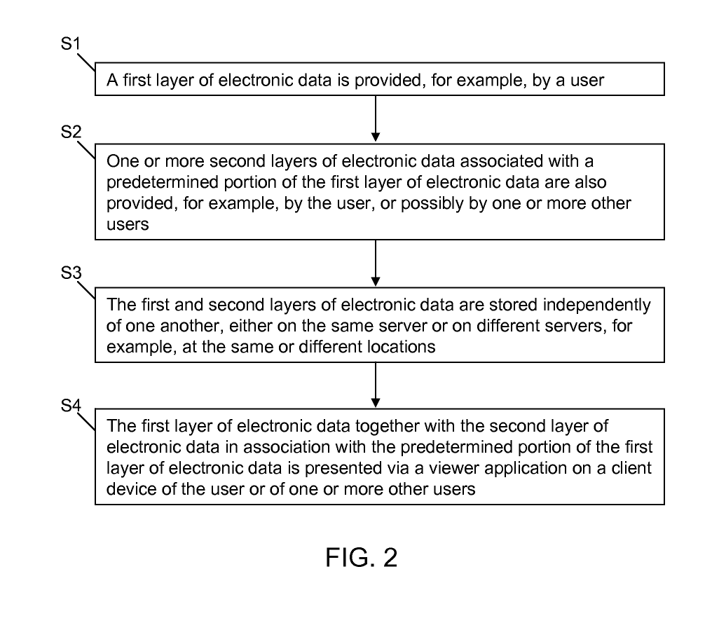

FIG. 2 is a flow chart that illustrates an overview example of the process of creating, storing, transferring and manipulating electronic data layers for embodiments of the invention. Referring to FIGS. 1 and 2, at S1, a first layer of electronic data is provided, for example, by the user 16. At S2, at least a second layer of electronic data associated with a predetermined portion of the first layer of electronic data is also provided, for example, by the user 16, or possibly by another user 20 or 22. At S3, the first and second layers of electronic data are stored independently of one another, either on the same server or on different servers, for example, at the same or different locations. Referring further to FIG. 2, at S4, the first layer of electronic data together with the second layer of electronic data in association with the predetermined portion of the first layer of electronic data can be accessed and presented via a viewer application on the client device 10 of other users 20 and/or 22.

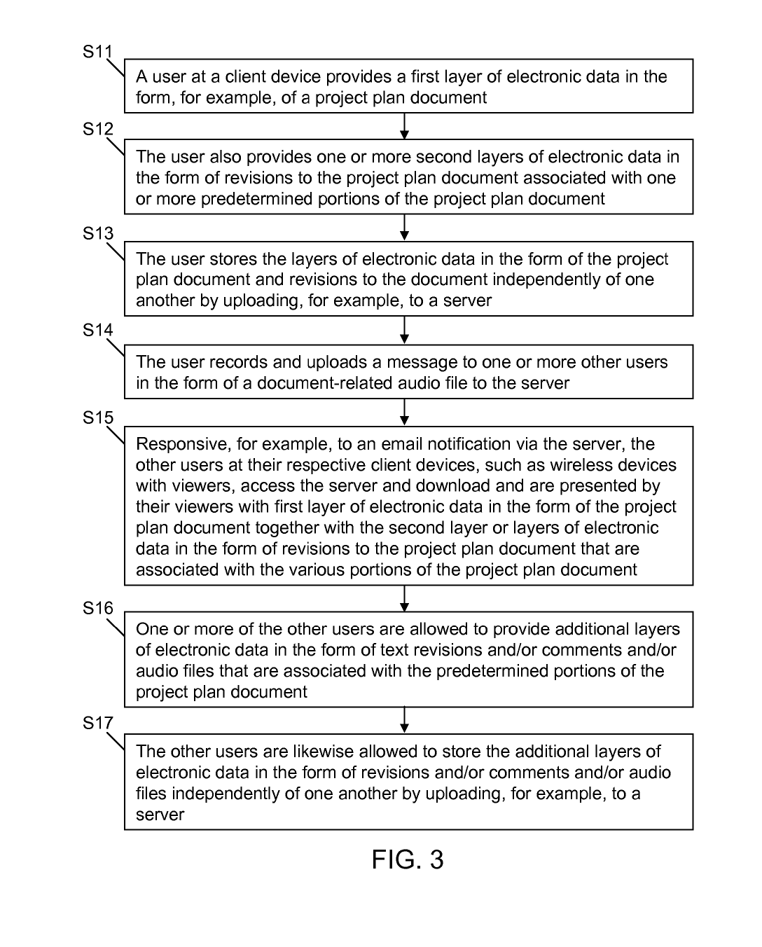

FIG. 3 is a flow chart that illustrates an example of the process of creating, storing, transferring and manipulating electronic data layers in the form of electronic data files for embodiments of the invention. Referring to FIGS. 1 and 3, at S11, a user 16 at a client device 10 provides a first layer of electronic data in the form of a project plan document. At S12, the user 16 also provides one or more second layers of electronic data in the form of revisions to the project plan document associated with one or more predetermined portions of the project plan document, and at S 13, the user 16 stores the layers of electronic data in the form of the project plan document and revisions independently of one another by uploading, for example, to a server 14. At S14, the user 16 records and uploads a message to other users, such as users 20 and/or 22 in the form of an audio file to the server 14.

Referring further to FIGS. 1 and 3, at S15, responsive, for example, to an email notification via the server 14, one or more second users, such as user 20 and/or user 22 at a client device 10, such as a wireless device with a viewer, access the server 14 and download and are presented by the viewer with the first layer of electronic data in the form of the project plan document together with the second layer or layers of electronic data in the form of revisions to the project plan document that are associated with the various portions of the project plan document. At S16, one or more of the second users 20 and/or 22 are allowed to provide one or more additional layers of electronic data in the form of text revisions and/or comments and/or an audio file that are associated with one or more predetermined portions of the project plan document, and at S17, users 20 and/or 22 are likewise allowed to store the additional layers of electronic data independently of one another by uploading, for example, to the server or servers 14.

As will be appreciated, the foregoing provides an overview of the features of the present invention and should not be read as limiting. The data layers of the present invention are capable of multiple advantageous uses as replacements for current data file technology, and for uses not capable of being handled by current data file technology.

Various preferred embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

What is claimed is:

1. A method for creating, storing, transferring and manipulating electronic data layers, comprising:
providing at least a first layer of electronic data;
providing at least a second layer of electronic data associated with a predetermined portion of the first layer of electronic data;
storing the first and second layers of electronic data independently of one another; and
presenting the first layer of electronic data together with the second layer of electronic data in association with the predetermined portion of the first layer of electronic data.

2. The method of claim 1, the limitations of which are incorporated herein by this reference, wherein the first layer of electronic data further comprises a word processing electronic data file consisting at least in part of electronic data relating to a substance and layout of a document.

3. The method of claim 1, the limitations of which are incorporated herein by this reference, wherein the first layer of electronic data further comprises multimedia electronic data consisting of at least one of audio, video, picture, and graphic electronic data.

4. The method of claim 1, the limitations of which are incorporated herein by this reference, wherein the first layer of electronic data further comprises multimedia electronic data within an original formatted text file.

5. The method of claim 1, the limitations of which are incorporated herein by this reference, wherein the first layer of electronic data further comprises electronic data representing any form of presenting data to a user.

6. The method of claim 5, the limitations of which are incorporated herein by this reference, wherein the first layer of electronic data further comprises electronic data representing any of a text file, a document file, a picture file, a graphic file, a video file, an HTML file, and an audio file.

7. The method of claim 5, the limitations of which are incorporated herein by this reference, wherein the first and second layers of electronic data further comprise electronic data files of different sizes.

8. The method of claim 1, the limitations of which are incorporated herein by this reference, wherein the second layer of electronic data further comprises electronic data representing an audio file with a recorded message replayable for a user while viewing a word processing file represented by the first layer of electronic data.

9. The method of claim 1, the limitations of which are incorporated herein by this reference, wherein the second layer of electronic data further comprises electronic data representing text that is associated with text represented by the predetermined portion of the first layer of electronic data.

10. The method of claim 1, the limitations of which are incorporated herein by this reference, wherein the second layer of electronic data further comprises electronic data representing any of a text file, a document file, a picture file, a graphic file, a video file, an HTML file, and an audio file.

11. The method of claim 1, the limitations of which are incorporated herein by this reference, wherein the second layer of electronic data further comprises electronic data representing an audio file having information relating to a predetermined portion of text represented by the first layer of electronic data.

12. The method of claim 11, the limitations of which are incorporated herein by this reference, wherein the audio file further comprises electronic data representing comments on the predetermined portion of text represented by the first layer of electronic data.

13. The method of claim 1, the limitations of which are incorporated herein by this reference, further comprising providing a plurality of additional layers of electronic data associated with at least one predetermined portion of the first layer of electronic data.

14. The method of claim 13, the limitations of which are incorporated herein by this reference, wherein the plurality of additional layers of electronic data further comprise electronic data representing files relating to a plurality of different predetermined portions of the first layer of electronic data.

15. The method of claim 1, the limitations of which are incorporated herein by this reference, wherein providing at least the second layer of electronic data further comprises providing a viewer having coordinate generating code that identifies a position of the predetermined portion of the first layer of electronic data with which to associate the second layer of electronic data.

16. The method of claim 1, the limitations of which are incorporated herein by this reference, wherein storing the first and second layers of electronic data further comprises collating the first and second layers of electronic data.

17. The method of claim 1, the limitations of which are incorporated herein by this reference, wherein storing the first and second layers of electronic data further comprises storing the first and second layers of electronic data as separate electronic data files.

18. The method of claim 1, the limitations of which are incorporated herein by this reference, wherein storing the first and second layers of electronic data further comprises providing a data table that references a storage location for each of the layers.

19. The method of claim 1, the limitations of which are incorporated herein by this reference, further comprising presenting the first layer of electronic data together with the second layer of electronic data in association with the predetermined portion of the first layer of electronic data on a communication device via a communications network

20. The method of claim 19, the limitations of which are incorporated herein by this reference, wherein the communication device further comprises a wireless communication device.

21. The method of claim 1, the limitations of which are incorporated herein by this reference, further comprising presenting the first layer of electronic data together with the second layer of electronic data in association with the predetermined portion of the first layer of electronic data on a plurality of a different communication devices independently of one another.

22. The method of claim 1, the limitations of which are incorporated herein by this reference, further comprising presenting the first layer of electronic data together with the second layer of electronic data in association with the predetermined portion of the first layer of electronic data simultaneously on a plurality of different communication devices independently of one another.

23. Machine-readable media embodying a file structure for creating, storing, transferring and manipulating electronic data layers, comprising:
a first layer of electronic data stored on a data storage device;
at least a second layer of electronic data associated with a predetermined portion of the first layer of electronic data and stored on a data storage device independently of the first layer of electronic data; and
a viewer coupled to the data storage device via a network presenting the first layer of electronic data together with the second layer of electronic data in association with the predetermined portion of the first layer of electronic data.

24. Machine-readable medium on which is encoded program code for creating, storing, transferring and manipulating electronic data layers, the program code comprising instructions for:
providing at least a first layer of electronic data;
providing at least a second layer of electronic data associated with a predetermined portion of the first layer of electronic data;
storing the first and second layers of electronic data independently of one another; and
presenting the first layer of electronic data together with the second layer of electronic data in association with the predetermined portion of the first layer of electronic data.

25. A computer system for creating, storing, transferring and manipulating electronic data layers, comprising:
a database storing at least a first layer of electronic data;
one of the database and a second database storing at least a second layer of electronic data associated with a predetermined portion of the first layer of electronic data; and
a viewer coupled to the database storing the first layer of electronic data and said one of the database and the second database storing at least the second layer of electronic data via a network presenting the first layer of electronic data together with the second layer of electronic data in association with the predetermined portion of the first layer of electronic data.
